(19) United States
(12) Patent Application Publication
(10) Pub. No.: US 2024/0338956 A1
(43) Pub. Date: Oct. 10, 2024

(54) TARGET LABELING METHOD AND APPARATUS, DEVICE AND STORAGE MEDIUM

(71) Applicant: AUTEL ROBOTICS CO., LTD., Shenzhen (CN)

(72) Inventor: Xueying JING, Shenzhen (CN)

(21) Appl. No.: 18/627,605

(22) Filed: Apr. 5, 2024

(30) Foreign Application Priority Data
Apr. 7, 2023 (CN) 202310406448.2

(51) Int. Cl. G06V 20/70; G06T 7/70; G06T 11/20; G06V 20/17

(52) U.S. Cl. CPC G06V 20/70; G06T 7/70; G06T 11/203; G06V 20/17; G06T 2207/10032

(57) ABSTRACT

Embodiments of the present disclosure disclose a target labeling method and apparatus, a device and a storage medium The target labeling method includes: acquiring a first real-time image sent by an unmanned aerial vehicle and first target information of at least one target identified in the first real-time image; rendering the at least one target at a corresponding position in the first real-time image according to the first target information of the at least one target so as to label the at least one target; and displaying the rendered first real-time image.

### CROSS REFERENCE TO RELATED DISCLOSURE

This application is filed based upon and claims priority to Chinese patent application 202310406448.2 filed on Apr. 7, 2023 and entitled “Target labeling methods, devices, appliances and storage media” the entire disclosure of which is incorporated herein by reference for all purposes.

### BACKGROUND

At present, the unmanned aerial vehicle capturing technology has developed rapidly, and unmanned aerial vehicle images have been widely used in various fields. For example, unmanned aerial vehicle images can be used for monitoring traffic flow and pedestrian flow, tracking moving targets, and the like. These applications also propose wider requirements for target labeling based on unmanned aerial vehicle images.

In the prior art, a manual labeling manner is mainly used, and the positions of target objects are mostly labeled on a map. This manner has low efficiency and cannot display together with real-time images, resulting in poor user experience.

### SUMMARY

The present disclosure relates to the technical field of mobile robots, and in particular to a target labeling method and apparatus, a device and a storage medium.

Embodiments of the present disclosure aim to provide a target labeling method and apparatus, a device and a storage medium to solve the problems of low efficiency and poor display effect caused by manual labeling in the prior art.

In order to solve the above technical problems, the embodiments of the present disclosure provide the following technical solutions.

According to a first aspect of the present disclosure, a target labeling method is provided. The method includes:
acquiring a first real-time image sent by an unmanned aerial vehicle and first target information of at least one target identified in the first real-time image, the first target information including first image coordinates of the target in the first real-time image;
rendering the at least one target at a corresponding position in the first real-time image according to the first target information of the at least one target so as to label the at least one target; and
displaying the rendered first real-time image.

According to a second aspect of the present disclosure, a target labeling apparatus is provided. The target labeling apparatus includes:
a data acquisition module, configured to acquire a first real-time image sent by an unmanned aerial vehicle and first target information of at least one target identified in the first real-time image, the first target information including first image coordinates of the target in the first real-time image;
a target labeling module, configured to render the at least one target at a corresponding position in the first real-time image according to the first target information of the at least one target so as to label the at least one target; and
an image display module, configured to display the rendered first real-time image.

According to still another aspect of the present disclosure, an electronic device is provided. The electronic device includes a memory, a processor and a computer program stored in the memory and capable of running. The processor, when executing the program, implements steps of any of the above target labeling methods.

According to yet another aspect of the present disclosure, a computer-readable storage medium is provided. A computer program is stored in the computer-readable storage medium. When the computer program is executed by a processor, the processor executes steps of any of the above target labeling methods.

The embodiments of the present disclosure have the following beneficial effects. Different from the situation in the prior art, in the embodiments of the present disclosure, first, a first real-time image sent by an unmanned aerial vehicle and first target information of at least one target identified in the first real-time image are acquired; then, the at least one target is rendered at a corresponding position in the first real-time image according to the first target information of the at least one target so as to label the at least one target; and then, the rendered first real-time image is displayed. By adopting the present disclosure, targets can be automatically labeled in real-time images, and labeling information and real-time videos are displayed together, thus improving data processing efficiency and information display effect of the unmanned aerial vehicle, and reducing labor costs.

### BRIEF DESCRIPTION OF THE DRAWINGS

One or more embodiments are exemplarily described with reference to the corresponding figures in the accompanying drawings, and these exemplary descriptions do not constitute a limitation on the embodiments. Elements in the accompanying drawings that have same reference numerals are represented as similar elements. Unless otherwise particularly stated, the figures in the accompanying drawings are not drawn to scale.

FIG. 1 is a schematic flowchart of a target labeling method provided in Embodiment 1 of the present disclosure;

FIG. 2 is a schematic flowchart of another target labeling method provided in Embodiment 1 of the present disclosure;

FIG. 3 is a schematic diagram showing all vehicles labeled in a first real-time image provided in Embodiment 1 of the present disclosure;

FIG. 4 is a schematic diagram showing a tracked vehicle labeled in a second real-time image provided in Embodiment 1 of the present disclosure;

FIG. 5 is a schematic structural diagram of a target labeling apparatus provided in Embodiment 2 of the present disclosure; and

FIG. 6 is a schematic structural diagram of an electronic device provided in Embodiment 3 of the present disclosure.

### DETAILED DESCRIPTION

To make the objectives, technical solutions and advantages of the embodiments of the present disclosure clearer, the following clearly and completely describes the technical solutions in the embodiments of the present disclosure with reference to the accompanying drawings in the embodiments of the present disclosure. Apparently, the described embodiments are merely some embodiments of the present disclosure rather than all of the embodiments. All other embodiments obtained by a person of ordinary skill in the art based on the embodiments in the present disclosure without creative efforts shall fall within the protection scope of the present disclosure.

Technical features involved in implementations of the present disclosure that are described below may be combined with each other provided that no conflict occurs.

### Embodiment 1

According to an embodiment of the present disclosure, a target labeling method is provided. It should be noted that steps shown in the flowchart of the accompanying drawing may be executed in a computer system such as a set of computer executable instructions. Moreover, although a logical order is shown in the flowchart, in some cases, the steps shown or described may be executed in an order different from the order here.

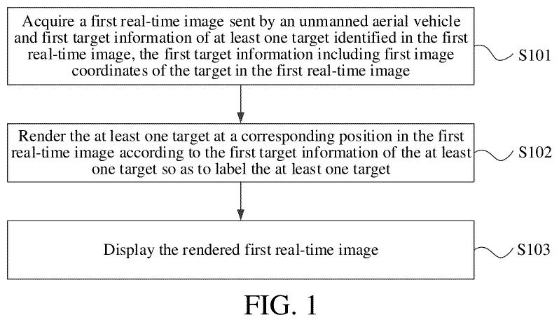

Referring to FIG. 1, FIG. 1 is a schematic flowchart of a target labeling method provided in Embodiment 1 of the present disclosure. The method can be applied to a background monitoring system of an unmanned aerial vehicle. In order to facilitate the description of the steps of the method shown in FIG. 1, the background monitoring system is used as an implementation subject of the method. The method includes the following specific steps:

Step S101: A first real-time image sent by an unmanned aerial vehicle and first target information of at least one target identified in the first real-time image are acquired, and the first target information includes first image coordinates of the target in the first real-time image.

The unmanned aerial vehicle sends the first real-time image and the first target information of all targets identified in the first real-time image to the background monitoring system through a ground control end.

In some embodiments of the present disclosure, the unmanned aerial vehicle monitors specific targets within a preset range based on a preset monitoring plan. The monitoring plan includes identification information of the target to be monitored, such as the type of the target, features of the target, and other information that can identify the target. The unmanned aerial vehicle identifies the captured video picture according to the identification information, and returns the first target information of one or more identified targets to the background monitoring system.

In some other embodiments of the present disclosure, the unmanned aerial vehicle labels specific targets based on instructions of the background monitoring system. Specifically, the background monitoring system sends a target labeling request to the unmanned aerial vehicle, and the target labeling request carries identification information of a target. Receiving the target labeling request, the unmanned aerial vehicle identifies the first real-time image based on the identification information of the target, and returns the first target information of at least one target that conforms to the identification information to the background monitoring system.

The first target information at least includes first image coordinates of the target in the first real-time image. Preferably, the first target information further includes first attribute information of the target. The first attribute information of the target may include other information such as contour information of the target and the type of target. In a practical application, the content carried by the first target information can be determined according to the type of a target or the need of a task. For example, when a pedestrian is labeled, the first target information may include the position, gender, age, height, hair style and the like of the pedestrian; and when an animal is labeled, the first target information may include the position of the animal, the type of the animal, contour information, and the like.

Step S102: The at least one target is rendered at a corresponding position in the first real-time image according to the first target information of the at least one target so as to label the at least one target.

After acquiring the first real-time image and the first target information corresponding to each target, the background monitoring system renders the at least one target in a preset first labeling manner at a corresponding position in the first real-time image.

In some embodiments of the present disclosure, the preset first labeling manner is a non-contour labeling manner, which is preset by a user in a program or selected from multiple labeling manners when the target labeling request is initiated. Optionally, the labeling manner includes: by taking a first image position of a target as a center, a geometric shape with a preset size is drawn, or a preset picture is pasted to the first image position.

In some other embodiments of the present disclosure, the preset first labeling manner is a contour labeling manner. In this manner, the first target information includes the contour information of the target, and the contour of the target can be rendered in the first real-time image according to the first image position of the target and the contour information of the target.

In other embodiments of the present disclosure, when the first target information further includes the type, name and other additional information of the target, a corresponding labeling manner can be set to render these information.

In an embodiment of the present disclosure, the first target information can also be matched with a preset model library to acquire more additional information of the target so as to be convenient for users to view. Specifically, first, positioning information of the at least one target in an actual environment is determined according to the first image coordinates of the at least one target; then, the positioning information is matched with position information of each target in the preset model library to acquire additional information of the at least one target; and the at least one target is rendered at a corresponding position in the first real-time image according to the first target information of the at least one target and the additional information of the at least one target so as to label the first target information and the additional information of the at least one target. The step of determining positioning information of the at least one target in an actual environment according to the first image coordinates of the at least one target includes: Flight data of the unmanned aerial vehicle is acquired, and the positioning information of the at least one target in the actual environment is determined according to the flight data of the unmanned aerial vehicle and the first image coordinates of the at least one target. The flight data includes the attitude, speed, terrain clearance, GPS position information and the like of the unmanned aerial vehicle.

Step S103: the rendered first real-time image is displayed.

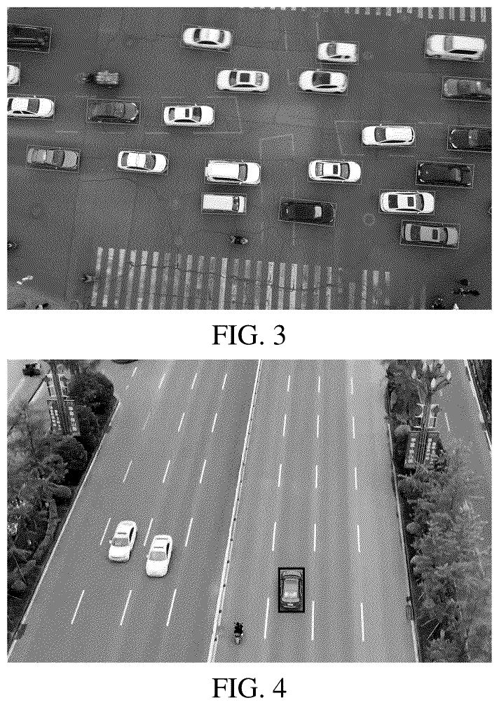

FIG. 3 is a schematic diagram showing all vehicles labeled in a first real-time image provided in Embodiment 1 of the present disclosure. In the figure, each vehicle is labeled in a contour labeling manner and then displayed in the first real-time image.

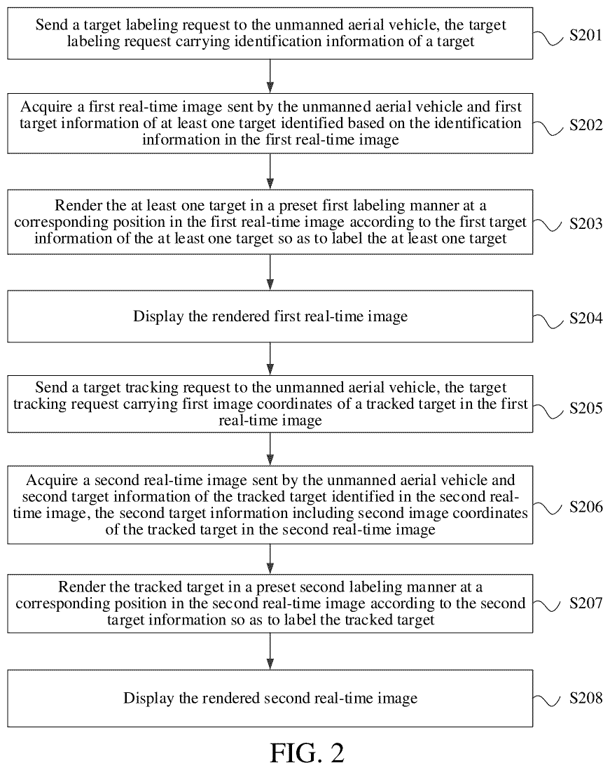

Referring to FIG. 2, FIG. 2 is a schematic flowchart of another target labeling method provided in Embodiment 1 of the present disclosure. The method can be applied to a background monitoring system of an unmanned aerial vehicle. The method includes the following specific steps:

Step S201: A target labeling request is sent to the unmanned aerial vehicle, and the target labeling request carries identification information of a target.

In an embodiment of the present disclosure, after the unmanned aerial vehicle is online, a video picture is transmitted to the background monitoring system and displayed, and the background monitoring system acquires the identification information of the target to be labeled currently, generates the target labeling request according to the identification information of the target, and sends the target labeling request to the unmanned aerial vehicle. The identification information of the target includes type information of the target, feature information of the target, and other information that can be used for identifying the target.

Step S202: A first real-time image sent by the unmanned aerial vehicle and first target information of at least one target identified based on the identification information in the first real-time image are acquired.

After receiving the target labeling request, the unmanned aerial vehicle analyzes the identification information of the target, performs identification based on the identification information in the captured first real-time image through functional modules such as image detection and target identification to obtain first target information of each target identified in the first real-time image, and returns the first real-time image and the first target information corresponding to each target to the background monitoring system.

Step S203: The at least one target is rendered in a preset first labeling manner at a corresponding position in the first real-time image according to the first target information of the at least one target so as to label the at least one target.

The specific description of the first labeling manner is mentioned above.

Step S204: The rendered first real-time image is displayed.

Step S205: A target tracking request is sent to the unmanned aerial vehicle, and the target tracking request carries first image coordinates of a tracked target in the first real-time image.

In an embodiment of the present disclosure, a user selects the target to be tracked in the rendered first real-time image. For example, a user selects a tracked target through a selection box, and the background monitoring system determines first image coordinates of the tracked target in the first real-time image based on the selection information of the user, generates a target tracking request according to the first image coordinates, and sends the target tracking request to the unmanned aerial vehicle.

Step S206: A second real-time image sent by the unmanned aerial vehicle and second target information of the tracked target identified in the second real-time image are acquired, and the second target information includes second image coordinates of the tracked target in the second real-time image.

After receiving the target tracking request sent by the background monitoring system, the unmanned aerial vehicle analyzes the first image coordinates of the tracked target in the first real-time image from the target tracking request, thus locking the tracked target to initiate tracking.

During the tracking process, the unmanned aerial vehicle captures a second real-time image including the tracked target, and identifies attribute information of the tracked target in the second real-time image to obtain the second target information. The second target information at least includes the second image coordinates of the tracked target in the second real-time image. Optionally, the second target information further includes second attribute information of the target. Preferably, the information content of the second attribute information is more than the information content of the first attribute information. For example, when the tracked target is a vehicle, the second attribute information may further include vehicle contour information, license plate number, vehicle brand, speed per hour, and the like. After the second target information is identified, the second real-time image and the second target information are sent to the background monitoring system.

Step S207: The tracked target is rendered in a preset second labeling manner at a corresponding position in the second real-time image according to the second target information so as to label the tracked target.

The second labeling manner may be the same as or different from the first labeling manner. Specific labeling manners can be defined by users.

In an embodiment of the present disclosure, the process of labeling the tracked target further includes: historical image coordinates of the tracked target in the second real-time image before current time are acquired; and a moving track of the tracked target is rendered in the second real-time image according to the historical image coordinates and the second image coordinates of the tracked target.

When finding that the tracked target is lost, the unmanned aerial vehicle sends target loss information to the background monitoring system, and the background monitoring system acquires the target loss information of the tracked target sent by the unmanned aerial vehicle; and relevant information indicating that the tracked target is lost is rendered in the second real-time image according to the target loss information.

Step S208: The rendered second real-time image is displayed.

FIG. 4 is a schematic diagram showing a tracked vehicle labeled in a second real-time image provided in Embodiment 1 of the present disclosure. It can be understood that if the second target information further includes attribute information such as the license plate number and vehicle speed of the tracked vehicle, the above attribute information can also be rendered in the second real-time image and then displayed.

During target tracking, the background monitoring system periodically acquires the second real-time image sent by the unmanned aerial vehicle and the second target information of the tracked target identified in the second real-time image, continuously renders the second real-time image according to the second target information, and then displays the second real-time image. When the target loss information sent by the unmanned aerial vehicle is received, after the relevant information indicating that the tracked target is lost is rendered in the second real-time image, a tracking end instruction is sent to the unmanned aerial vehicle, and the unmanned aerial vehicle ends tracking after receiving the tracking end instruction.

Alternatively, the step of rendering the at least one target at a corresponding position in the first real-time image according to the first target information of the at least one target so as to label the at least one target includes:

rendering a contour of the at least one target and/or a type of the at least one target in a preset first labeling manner at a corresponding position in the first real-time image according to the first target information of the at least one target.

Alternatively, the method further includes:
determining positioning information of the at least one target in an actual environment according to the first image coordinates of the at least one target;
matching the positioning information with position information of each target in a preset model library to acquire additional information of the at least one target; and
rendering the at least one target at a corresponding position in the first real-time image according to the first target information of the at least one target and the additional information of the at least one target so as to label the first target information and the additional information of the at least one target.

Alternatively, the method further includes:
sending a target labeling request to the unmanned aerial vehicle, the target labeling request carrying identification information of a target; and
acquiring the first real-time image sent by the unmanned aerial vehicle and the first target information of the at least one target identified based on the identification information in the first real-time image.

Alternatively, the method further includes:
sending a target tracking request to the unmanned aerial vehicle, the target tracking request carrying first image coordinates of a tracked target in the first real-time image;
acquiring a second real-time image sent by the unmanned aerial vehicle and second target information of the tracked target identified in the second real-time image, the second target information including second image coordinates of the tracked target in the second real-time image;
rendering the tracked target in a preset second labeling manner at a corresponding position in the second real-time image according to the second target information so as to label the tracked target; and displaying the rendered second real-time image.

Alternatively, the method further includes:
acquiring historical image coordinates of the tracked target in the second real-time image before current time; and
rendering a moving track of the tracked target in the second real-time image according to the historical image coordinates and the second image coordinates of the tracked target.

Alternatively, the method further includes:
acquiring target loss information of the tracked target sent by the unmanned aerial vehicle; and
rendering relevant information indicating that the tracked target is lost in the second real-time image according to the target loss information.

According to a target labeling method provided in an embodiment of the present disclosure, first, a first real-time image sent by an unmanned aerial vehicle and first target information of at least one target identified in the first real-time image are acquired; then, the at least one target is rendered at a corresponding position in the first real-time image according to the first target information of the at least one target so as to label the at least one target; and then, the rendered first real-time image is displayed. By adopting the present disclosure, targets can be automatically labeled in real-time images, and labeling information and real-time videos are displayed together, thus improving data processing efficiency and information display effect of the unmanned aerial vehicle, and reducing labor costs.

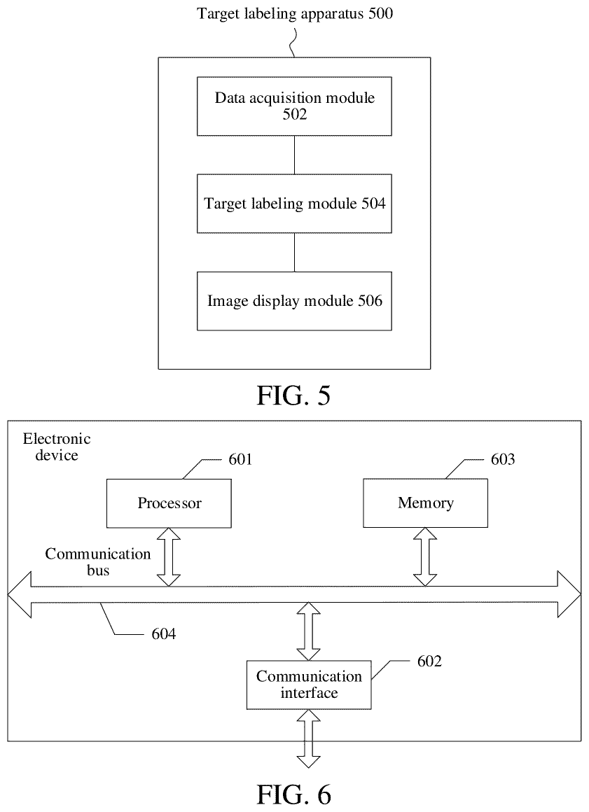

According to an embodiment of the present disclosure, a target labeling apparatus is provided. FIG. 5 is a schematic structural diagram of a target labeling apparatus provided in Embodiment 2 of the present disclosure. The target labeling apparatus 500 includes a data acquisition module 502, a target labeling module 504 and an image display module 506.

The data acquisition module 502 is configured to acquire a first real-time image sent by an unmanned aerial vehicle and first target information of at least one target identified in the first real-time image, and the first target information includes first image coordinates of the target in the first real-time image.

The target labeling module 504 is configured to render the at least one target at a corresponding position in the first real-time image according to the first target information of the at least one target so as to label the at least one target.

The image display module 506 is configured to display the rendered first real-time image.

The above apparatus can execute any of the target labeling methods in Embodiment, and has corresponding functional modules and beneficial effects of the method. The technical details which are not described in detail in this embodiment may refer to the target labeling methods provided in Embodiment of the present disclosure.

According to an embodiment of the present disclosure, an electronic device is provided. FIG. 6 is a schematic structural diagram of an electronic device provided in Embodiment 3 of the present disclosure. The electronic device may include a processor 601, a communication interface 602, a memory 603 and a communication bus 604. The processor 601, the communication interface 602 and the memory 603 communicate with each other through the communication bus 604. The processor 601 can call a logical instruction in the memory 603 to execute a target labeling method. The method includes the following: a first real-time image sent by an unmanned aerial vehicle and first target information of at least one target identified in the first real-time image are acquired, and the first target information includes first image coordinates of the target in the first real-time image; the at least one target is rendered at a corresponding position in the first real-time image according to the first target information of the at least one target so as to label the at least one target; and the rendered first real-time image is displayed.

In addition, when the logical instruction in the above memory 603 may be implemented in the form of a software functional unit and sold or used as an independent product, the logical instruction may be stored in several computer-readable storage media. Based on such an understanding, the technical solutions of the present disclosure essentially, or the part contributing to the prior art, or some of the technical solutions may be implemented in the form of a software product. The computer software product is stored in a storage medium and includes several instructions for instructing a computer device (which may be a personal computer, a server, a network device, or the like) to execute all or some of steps of the methods in Embodiment 1 of the present disclosure. The above-mentioned storage medium includes: various media capable of storing program codes, such as a USB flash drive, a mobile hard disk, a read-only memory (ROM), a random access memory (RAM), a magnetic disk, and an optical disc.

The above electronic device can execute any of the target labeling methods in Embodiment 1, and has corresponding functional modules and beneficial effects of the method. The technical details which are not described in detail in this embodiment may refer to the target labeling methods provided in Embodiment 1 of the present disclosure.

According to an embodiment of the present disclosure, a computer-readable storage medium is provided. The type of the computer-readable storage medium is described in Embodiment 3. A computer program is stored in the computer-readable storage medium. When the computer program is executed by a processor, the processor executes steps of the target labeling methods in Embodiment 1.

The above product can execute any of the target labeling methods in Embodiment 1, and has corresponding functional modules and beneficial effects of the method. The technical details which are not described in detail in this embodiment may refer to the target labeling methods provided in Embodiment of the present disclosure.

Through the description of the above implementations, a person skilled in the art can clearly understand that the implementations may be implemented by software in combination with a universal hardware platform, and may certainly be implemented by hardware. Based on such an understanding, the above technical solutions essentially or the part contributing to the prior art may be implemented in the form of a software product. The computer software product may be stored in a computer-readable storage medium, such as a ROM/RAM, a magnetic disk, or an optical disc, and includes several instructions for instructing a computer device (which may be a personal computer, a server, a network device, or the like) to execute the methods described in the embodiments or some parts of the embodiments.

Finally, it should be noted that the above embodiments are merely used for describing the technical solutions of the present disclosure, but are not intended to limit the present disclosure. Under the ideas of the present disclosure, the technical features in the above embodiments or different embodiments may also be combined, the steps may be implemented in any order, many other changes of different aspects of the present disclosure also exist as described above, and these changes are not provided in detail for simplicity. Although the present disclosure is described in detail with reference to the above-mentioned embodiments, a person of ordinary skill in the art should understand that the technical solutions recorded in the above-mentioned embodiments can still be modified, or part of the technical features can be equivalently replaced. However, the essence of the corresponding technical solutions does not depart from the scope of the technical solutions of the embodiments of the present disclosure due to these modifications or replacements.

What is claimed is:

1. A target labeling method, wherein the method comprises:
acquiring a first real-time image sent by an unmanned aerial vehicle and first target information of at least one target identified in the first real-time image, the first target information comprising first image coordinates of the target in the first real-time image;
rendering the at least one target at a corresponding position in the first real-time image according to the first target information of the at least one target so as to label the at least one target; and
displaying the rendered first real-time image.

2. The method according to claim 1, wherein the step of rendering the at least one target at a corresponding position in the first real-time image according to the first target information of the at least one target so as to label the at least one target comprises:
rendering a contour of the at least one target and/or a type of the at least one target in a preset first labeling manner at a corresponding position in the first real-time image according to the first target information of the at least one target.

3. The method according to claim 1, wherein the method further comprises:
determining positioning information of the at least one target in an actual environment according to the first image coordinates of the at least one target;
matching the positioning information with position information of each target in a preset model library to acquire additional information of the at least one target; and
rendering the at least one target at a corresponding position in the first real-time image according to the first target information of the at least one target and the additional information of the at least one target so as to label the first target information and the additional information of the at least one target.

4. The method according to claim 1, wherein the method further comprises:
sending a target labeling request to the unmanned aerial vehicle, the target labeling request carrying identification information of a target; and
acquiring the first real-time image sent by the unmanned aerial vehicle and the first target information of the at least one target identified based on the identification information in the first real-time image.

5. The method according to claim 4, wherein the method further comprises:
sending a target tracking request to the unmanned aerial vehicle, the target tracking request carrying first image coordinates of a tracked target in the first real-time image;
acquiring a second real-time image sent by the unmanned aerial vehicle and second target information of the tracked target identified in the second real-time image, the second target information comprising second image coordinates of the tracked target in the second real-time image;
rendering the tracked target in a preset second labeling manner at a corresponding position in the second real-time image according to the second target information so as to label the tracked target; and
displaying the rendered second real-time image.

6. The method according to claim 5, wherein the method further comprises:
acquiring historical image coordinates of the tracked target in the second real-time image before current time; and
rendering a moving track of the tracked target in the second real-time image according to the historical image coordinates and the second image coordinates of the tracked target.

7. The method according to claim 5, wherein the method further comprises:
acquiring target loss information of the tracked target sent by the unmanned aerial vehicle; and
rendering relevant information indicating that the tracked target is lost in the second real-time image according to the target loss information.

8. A target labeling apparatus, comprising:
a data acquisition module, configured to acquire a first real-time image sent by an unmanned aerial vehicle and first target information of at least one target identified in the first real-time image, the first target information comprising first image coordinates of the target in the first real-time image;
a target labeling module, configured to render the at least one target at a corresponding position in the first real-time image according to the first target information of the at least one target so as to label the at least one target; and
an image display module, configured to display the rendered first real-time image.

9. The target labeling apparatus according to claim 8, the target labeling module is further configured to:
render a contour of the at least one target and/or a type of the at least one target in a preset first labeling manner at a corresponding position in the first real-time image according to the first target information of the at least one target.

10. The target labeling apparatus according to claim 8, wherein the method further comprises:
determine positioning information of the at least one target in an actual environment according to the first image coordinates of the at least one target;
match the positioning information with position information of each target in a preset model library to acquire additional information of the at least one target; and
render the at least one target at a corresponding position in the first real-time image according to the first target information of the at least one target and the additional information of the at least one target so as to label the first target information and the additional information of the at least one target.

11. The target labeling apparatus according to claim 1, wherein the target labeling apparatus is further configured to:
send a target labeling request to the unmanned aerial vehicle, the target labeling request carrying identification information of a target; and
acquire the first real-time image sent by the unmanned aerial vehicle and the first target information of the at least one target identified based on the identification information in the first real-time image.

12. The target labeling apparatus according to claim 11, wherein the target labeling apparatus is further configured to:
send a target tracking request to the unmanned aerial vehicle, the target tracking request carrying first image coordinates of a tracked target in the first real-time image;
acquire a second real-time image sent by the unmanned aerial vehicle and second target information of the tracked target identified in the second real-time image, the second target information comprising second image coordinates of the tracked target in the second real-time image;
render the tracked target in a preset second labeling manner at a corresponding position in the second real-time image according to the second target information so as to label the tracked target; and
display the rendered second real-time image.

13. The target labeling apparatus according to claim 12, wherein the target labeling apparatus is further configured to:
acquire historical image coordinates of the tracked target in the second real-time image before current time; and
render a moving track of the tracked target in the second real-time image according to the historical image coordinates and the second image coordinates of the tracked target.

14. The target labeling apparatus according to claim 12, wherein the target labeling apparatus is further configured to:
acquire target loss information of the tracked target sent by the unmanned aerial vehicle; and
render relevant information indicating that the tracked target is lost in the second real-time image according to the target loss information.

15. An electronic device, comprising a memory, a processor and a computer program stored in the memory and capable of running, wherein the processor, when executing the program, implements steps of the target labeling method, wherein the method comprises:
acquiring a first real-time image sent by an unmanned aerial vehicle and first target information of at least one target identified in the first real-time image, the first target information comprising first image coordinates of the target in the first real-time image;
rendering the at least one target at a corresponding position in the first real-time image according to the first target information of the at least one target so as to label the at least one target; and
displaying the rendered first real-time image.

16. The electronic device according to claim 15, wherein the step of rendering the at least one target at a corresponding position in the first real-time image according to the first target information of the at least one target so as to label the at least one target comprises:
rendering a contour of the at least one target and/or a type of the at least one target in a preset first labeling manner at a corresponding position in the first real-time image according to the first target information of the at least one target.

17. The electronic device according to claim 15, wherein the method further comprises:
determining positioning information of the at least one target in an actual environment according to the first image coordinates of the at least one target;
matching the positioning information with position information of each target in a preset model library to acquire additional information of the at least one target; and
rendering the at least one target at a corresponding position in the first real-time image according to the first target information of the at least one target and the additional information of the at least one target so as to label the first target information and the additional information of the at least one target.
